(19) United States
(12) Patent Application Publication
(10) Pub. No.: US 2025/0065636 A1
(43) Pub. Date: Feb. 27, 2025

(54) PRINTING APPARATUS

(71) Applicant: CANON KABUSHIKI KAISHA, Tokyo (JP)

(72) Inventors: YUKIMICHI KIMURA, Kanagawa (JP); MASAAKI ISHIHARA, Tokyo (JP); SHUHEI YAMAGUCHI, Kanagawa (JP); KEN TAKENAGA, Kanagawa (JP); KOUSUKE TANAKA, Kanagawa (JP); DAIJU TAKEDA, Kanagawa (JP); ATSUSHI KOHNOTOH, Tokyo (JP); SHOGO NISHIE, Kanagawa (JP)

(21) Appl. No.: 18/797,971

(22) Filed: Aug. 8, 2024

(30) Foreign Application Priority Data
Aug. 25, 2023 (JP) 2023-137048

(51) Int. Cl. B41J 2/175; B41J 29/02; B41J 29/13

(52) U.S. Cl. CPC B41J 2/1752; B41J 2/17526; B41J 29/02; B41J 29/13

(57) ABSTRACT

Provided is a printing apparatus with improved operability for cartridge attachment and detachment. To this end, the printing apparatus includes a housing portion for detachably housing a cartridge having an element substrate that ejects liquid and a restriction portion that restricts movement of the cartridge in a horizontal direction intersecting with an insertion direction in which the cartridge is inserted to the housing portion.

### BACKGROUND OF THE INVENTION

### Field of the Invention

The present invention relates to a printing apparatus to which a head cartridge is attached.

### Description of the Related Art

Apparatuses are increasingly becoming compact in recent years, and cartridges are accordingly required to be slim in width. Also, in attachment of a cartridge to a carriage, the cartridge needs to be attached so that its head surface provided with a printhead does not hit the carriage.

Japanese Patent Laid-Open No. 2019-034437 discloses a configuration in which a cartridge has a protrusion formed thereon configured to come into contact with a guide portion formed on the inner wall of a carriage. In this configuration, a user inserts the cartridge into the carriage along the guide portion of the carriage while bringing the protrusion portion into contact with the guide portion. This configuration makes it possible to attach the cartridge without hitting the head surface of the cartridge against the carriage and therefore without damaging the printhead.

However, with the configuration having a protrusion portion like in Japanese Patent Laid-Open No. 2019-034437, there is a limit to how slim the cartridge can be. Meanwhile, without a protrusion portion like the one in Japanese Patent Laid-Open No. 2019-034437, there is a concern that the cartridge will not be properly guided by the carriage at the time of insertion, hitting its head surface against the carriage. In this way, with the conventional configuration, it is difficult to achieve a cartridge which is slim and offers favorable operability for attachment to and detachment from the carriage.

### SUMMARY OF THE INVENTION

Thus, the present invention provides a printing apparatus with improved operability for cartridge attachment and detachment.

To this end, a printing apparatus of the present invention includes a housing portion for detachably housing a cartridge having an element substrate that ejects liquid and a restriction portion configured to restricts movement of the cartridge in a horizontal direction intersecting with an insertion direction in which the cartridge is inserted to the housing portion, and the restriction portion is provided at the housing portion at a location upstream in the insertion direction.

The present invention can provide a printing apparatus with improved operability for cartridge attachment and detachment.

Further features of the present invention will become apparent from the following description of exemplary embodiments with reference to the attached drawings.

### BRIEF DESCRIPTION OF THE DRAWINGS

FIG. 1 is a perspective view showing a printing apparatus;

FIG. 2A is a perspective view showing head cartridges and a carriage;

FIG. 2B is a perspective view showing the head cartridges and the carriage;

FIG. 3A is a diagram showing the carriage in an open posture and the head cartridges immediately before insertion;

FIG. 3B is a diagram showing the carriage in the open posture and the head cartridges immediately before insertion;

FIG. 3C is a diagram showing the carriage in the open posture and the head cartridge immediately before insertion;

FIG. 3D is a diagram showing the carriage in the open posture and the head cartridge immediately before insertion;

FIG. 4A is a diagram showing the carriage in a closed posture after insertion of the head cartridges;

FIG. 4B is a diagram showing the carriage in the closed posture after insertion of the head cartridges;

FIG. 5A is a sectional view of the carriage where its cover is closed and the head cartridge is fixed;

FIG. 5B is a sectional view of the carriage where its cover is closed and the head cartridge is fixed;

FIG. 5C is a sectional view of the carriage where its cover is closed and the head cartridge is fixed;

FIG. 6A is a sectional view of the carriage where its cover is open and the head cartridge is fixed;

FIG. 6B is a sectional view of the carriage where its cover is open and the head cartridge is fixed;

FIG. 6C is a sectional view of the carriage where its cover is open and the head cartridges is fixed;

FIG. 7A is a perspective view showing a push spring and a push lever;

FIG. 7B is a perspective view showing the push spring and the push lever;

FIG. 8A is a sectional view showing the carriage;

FIG. 8B is a sectional view showing the carriage;

FIG. 8C is a sectional view showing the carriage;

FIG. 8D is a sectional view showing the carriage;

FIG. 9A is an enlarged view showing the push lever;

FIG. 9B is an enlarged view showing the push lever;

FIG. 10 is a perspective view of the printing apparatus to which a front cover and an operation panel are attached;

FIG. 11A is a view showing covers;

FIG. 11B is a view showing the covers;

FIG. 12A is a diagram showing the carriage with no cartridge attached thereto and a board; and

FIG. 12B is a diagram showing the carriage with no cartridge attached thereto and the board.

### DESCRIPTION OF THE EMBODIMENTS

### First Embodiment

A first embodiment of the present invention is described below with reference to the drawings.

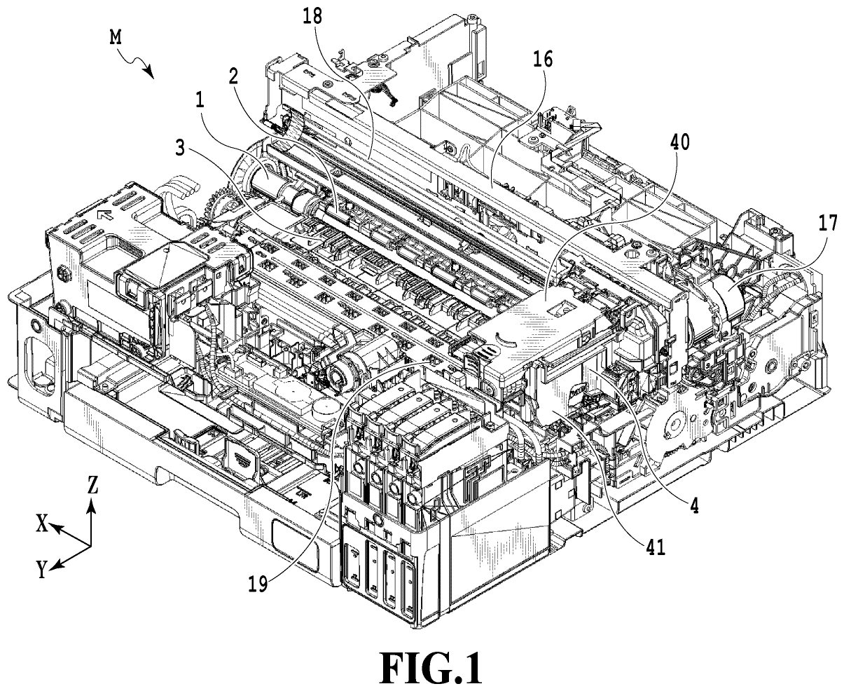

FIG. 1 is a perspective view of an inkjet printing apparatus (hereinafter also referred to simply as a printing apparatus) M to which the present embodiment can be applied. The printing apparatus M includes a feed roller (not shown) for feeding a printing medium (not shown), a conveyance roller 1 that conveys a printing medium, and pinch rollers 2 that follow the movement of the conveyance roller 1. The printing apparatus M further includes a carriage 4 to which a BK head cartridge (not shown) housing a black ink and a CL head cartridge (not shown) housing cyan, yellow, and magenta inks are attached.

A printing medium is conveyed onto a platen 3 while being sandwiched between the conveyance roller 1 and the pinch rollers 2, and an image is formed by ejection of inks (liquid) from element substrates of the head cartridges while the carriage 4 reciprocates in the main scanning direction, which is the X-direction.

Each of the head cartridges is detachably attached to the carriage 4. The carriage 4 is supported by a guide rail 16 in such a manner as to be movable in directions (the X-direction) intersecting with (orthogonal to) the conveyance direction of the printing medium (the Y-direction) while having the head cartridges attached thereto. The X-direction is a direction intersecting with (orthogonal to) a YZ-plane. The carriage 4 is moved in the X-direction by transmission of driving from a carriage unit drive motor 17 to a transmission belt 18. While the carriage 4 is moving, the head cartridges eject inks to the printing medium, forming an image of one band. The printing medium on which the image of one band has been printed is conveyed a predetermined conveyance amount in the Y-direction in order for an image of the next band to be formed thereon. The conveyance operation and the image formation operation are alternately repeated, forming an image on the entire printing medium.

The printing medium on which the image has been formed is conveyed further downstream in the conveyance direction by the conveyance roller 1 and the pinch rollers 2 that follow the movement of the conveyance roller 1 and is discharged onto a discharge tray (not shown) by a discharge roller (not shown) and spurs 19. The carriage 4 includes a housing portion 41 where the head cartridges are detachably mounted and a cover 40 (a cover portion) which is turnably attached to the housing portion 41 and which covers the head cartridges attached thereto. In a closed state, the cover 40 extends in the Y-direction, presses the head cartridges, and is fixed relative to the carriage 4.

The printing apparatus M is a serial-scan inkjet printing apparatus that forms an image on a printing medium by ejecting ink from moving head cartridges.

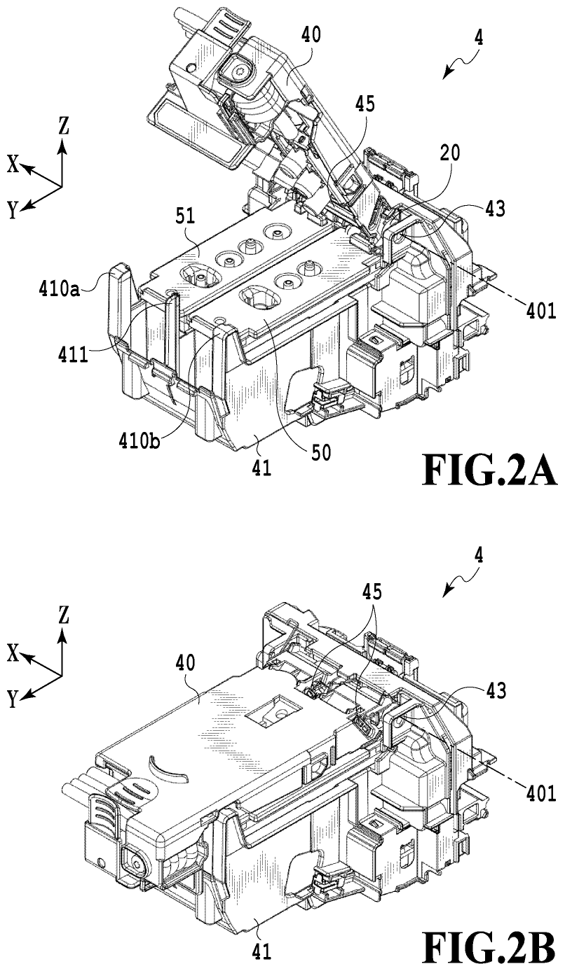

FIGS. 2A and 2B are perspective views showing the carriage 4 in which a CL head cartridge 50 and a BK head cartridge 51 are mounted. FIG. 2A is a perspective view showing a state where the cover 40 is open (an open posture), and FIG. 2B is a perspective view showing a state where the cover 40 is closed (a closed posture) by being turned about a turning center 401 from the state in FIG. 2A where the cover 40 is open to a position where the head cartridges are fixed.

The cover 40 is pivotally supported in such a manner as to be able to turn about the turning center 401 which is a bearing portion 43 of the carriage 4. The cover 40 is configured to be biased by an elastic member 20 in a rotation direction into the open posture and stay open (in the open posture). Also, the cover 40 is provided with head set cams 45 (a press portion) capable of pressing and biasing the head cartridges in the closed posture and is also provided with head set cam springs (a biasing member) (not shown) that bias the head set cams 45. In a state where the cover 40 is open, the head cartridges are not in contact with the head set cams 45. In a state where the cover 40 is closed, the head cartridges are biased by the head set cams 45 and are fixed in position relative to the housing portion 41 of the carriage 4.

The housing portion 41 of the carriage 4 includes restriction portions 410a, 410b at positions which are at the entry side of the carriage 4 in terms of the insertion direction of the head cartridges, i.e., at its downstream end portion in the Y-direction. Also, a restriction rib 411 is provided between the restriction portion 410a and the restriction portion 410b. The restriction portions 410a, 410b and the restriction rib 411 are in such shapes as to extend upward. Note that the restriction portion 410a, the restriction portion 410b, and the restriction rib 411 will be described in detail later.

Although the present embodiment describes the carriage 4 that can carry two cartridges, the CL head cartridge 50 and the BK head cartridge 51, the present invention is not limited to this. In other words, the carriage may carry three or more cartridges or a single cartridge. In a case of a carriage that carries a single cartridge, the restriction portions 410a, 410b will suffice. In other words, it suffices if movements in the X-direction are restricted at the time of insertion of the cartridge into the housing portion 41. Note that the CL head cartridge 50 and the BK head cartridge 51 may be hereinafter collectively referred to simply as head cartridges 50, 51.

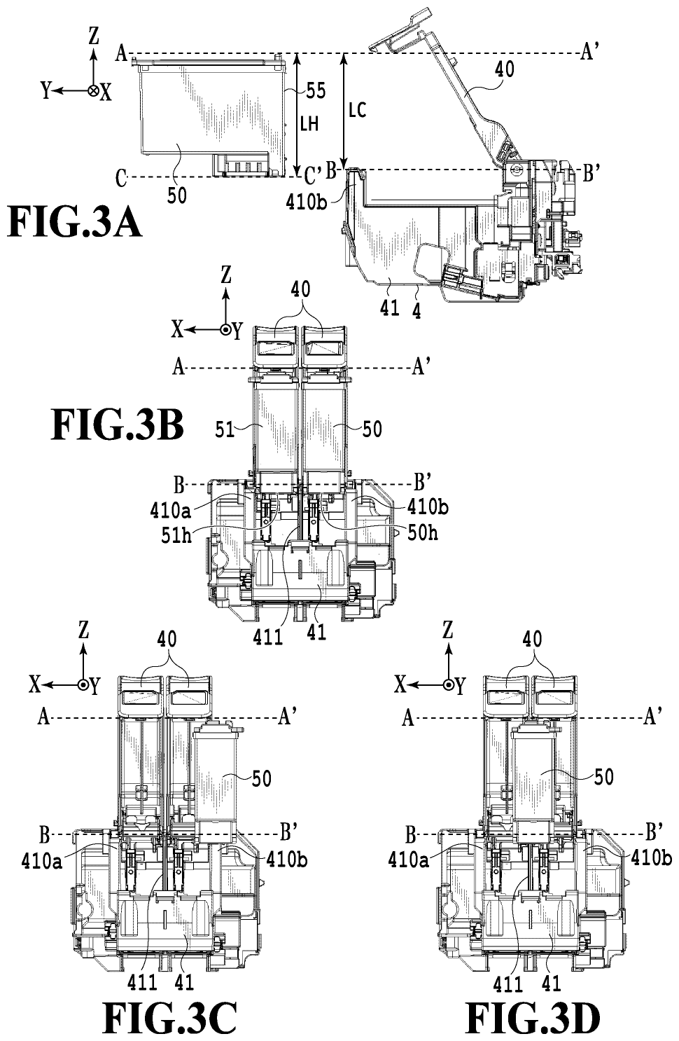

FIGS. 3A to 3D are diagrams showing the carriage 4 in the open posture and the head cartridges 50, 51 immediately before insertion, FIG. 3A showing a side view and FIG. 3B showing a front view (a view seen in the +Y-direction side). Line segments A-A′ and B-B′ shown in FIG. 3A and line segments A-A′ and B-B′ shown in FIG. 3B indicate the same positions in the Z-direction. The line segment A-A′ in FIGS. 3A and 3B indicates the positions of the upper edges (the top surfaces) of the head cartridges and the position of the upper edge of an insertion opening of the carriage 4 (the Y-direction tip end portion of the cover), and the line segment B-B′ indicates the positions of the upper edge portions of the restriction portions 410a, 410b and the restriction rib 411. Also, a line segment C-C′ in FIG. 3A indicates the positions of the lower edges (the bottom surfaces) of the head cartridges 50, 51.

The head cartridges 50, 51 are provided with printhead portions 50h, 51h, respectively, at their lowermost surfaces in the insertion direction. The printhead portions 50h, 51h each have an element substrate for ejecting ink. In the present embodiment, as shown in FIG. 3, the carriage 4 is provided with the cover 40, and the head cartridges 50, 51 cannot be inserted into the housing portion 41 only by being moved in the −Z-direction because the cover 40 gets in the way.

In the present embodiment, first, the head cartridges 50, 51 are moved mainly in the −Y-direction to enter the housing portion 41 of the carriage 4. After that, the head cartridges 50, 51 are inserted into the housing portion 41 by being rotated, moved in the −Y-direction, and moved in the −Z-direction.

In FIG. 3A, the line segment C-C′ indicates the positions of the lower edge portions of the head cartridges, i.e., the positions of the head surfaces of the printhead portions 50h, 51h, where ejection ports are arrayed. The length (distance) LH of the head cartridges in the Z-direction defined by the line segment A-A′ and the line segment C-C′ is longer than the length (distance) LC of the insertion opening (an entry for insertion) of the carriage 4 in the Z-direction defined by the line segment A-A′ and the line segment B-B′. The length (distance) LH is the distance from the bottom surfaces to the top surfaces of the cartridges 50, 51, and the length (distance) LC is a vertical distance between an upper edge portion of the restriction portion 410b and a rear end portion of the cover 40 in terms of the insertion direction. Also, the restriction portions 410a, 410b are provided at a Y-direction end portion of the housing portion 41, and the restriction rib 411 is provided between the restriction portion 410a and the restriction portion 410b. Thus, unless the head cartridges 50, 51 are in correct positions in the X-direction, the head cartridges 50, 51 cannot enter the housing portion 41 in the −Y-direction straight from the position in FIG. 3A. FIGS. 3C and 3D are each a diagram showing the head cartridge 50 that a user is trying to insert from a position displaced in the X-direction from a correct position. FIG. 3C is a diagram where the head cartridge 50 is trying to be inserted from a position displaced rightward as seen from the front of the apparatus (the +Y-direction). In the state shown in FIG. 3C, a right side portion of the head cartridge 50 comes into contact with the restriction portion 410b and cannot be inserted any farther. Meanwhile, FIG. 3D is a diagram where the head cartridge 50 is trying to be inserted from a position displaced leftward as seen from the front of the apparatus (the +Y-direction). In the state shown in FIG. 3D, a left side portion of the head cartridge 50 comes into contact with the restriction rib 411 and cannot be inserted any farther. The restriction portion 410a similarly offers an effect of helping prevent the head cartridge 51 from being inserted from a position displaced leftward. In this way, the restriction portion 410a, the restriction portion 410b, and the restriction rib 411 help prevent the head cartridges 50, 51 from being inserted to a position displaced in the X-direction. Insertion of the head cartridge 50 is mainly described here.

As described earlier, in insertion of the head cartridge 50 to the housing portion 41, first, the head cartridge 50 is inserted while being moved mainly in the −Y-direction. In the moving of the head cartridge 50 in the −Y-direction, the head cartridge 50 enters the housing portion 41 with its surface 55 being in the lead. The length LH of the head cartridge 50 in the Z-direction is longer than the length LC of the insertion opening of the carriage 4 in the Z-direction. Thus, in the movement in the −Y-direction, the head cartridge 50 is restricted in its movements in the X-direction by the restriction rib 411 and the restriction portion 410b at an early stage of the insertion to the carriage 4. The restriction portion 410a, the restriction portion 410b, and the restriction rib 411 are located at the downstream side of the housing portion 41 in the Y-direction (the upstream side in the insertion direction of the head cartridges 50, 51). Thus, the head cartridges 50, 51 are inserted into the housing portion 41 while moving in the −Z-direction and rotating on the YZ-plane, with their positions in the X-direction being restricted by the restriction rib 411 and the restriction portion 410b.

In this way, at the time of insertion, the head cartridge 50 has such a positional relation as not to be insertable into the housing portion 41 except along a predetermined insertion path because its position in the X-direction is restricted by the restriction rib 411 and the restriction portion 410b at an early stage of the insertion. Also, as shown in FIG. 3B, along the predetermined insertion path for the head cartridge 50, the head cartridge 50 can be inserted into the housing portion 41 without coming into contact with the restriction rib 411 or the restriction portion 410b. In other words, the restriction rib 411 and the restriction portion 410b are members that restrict the X-direction position of the head cartridge 50 at the time of insertion of the head cartridge 50 and also serve as guides for the head cartridge 50 being inserted. Also, as shown in FIG. 3B, as for the head cartridge 51, the restriction portion 410a and the restriction rib 411 similarly restrict and guide the insertion position.

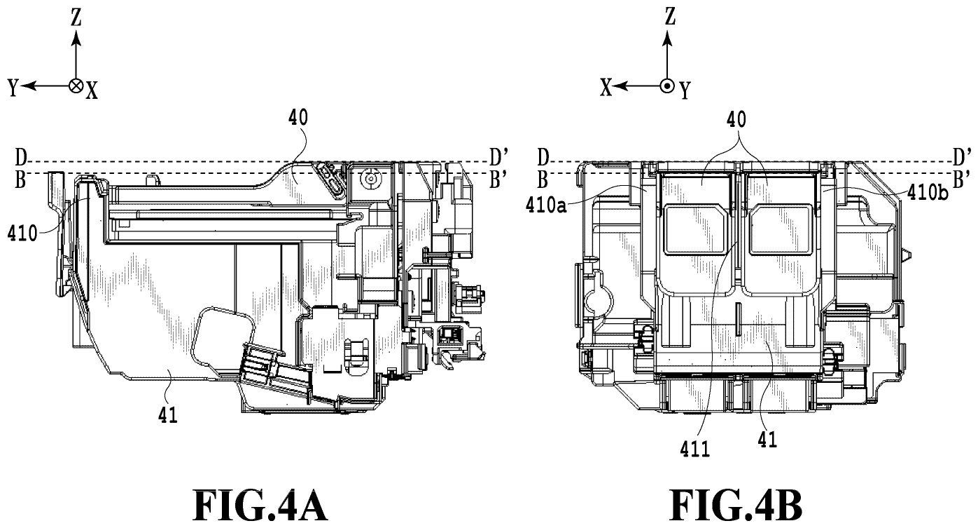

FIGS. 4A and 4B are diagrams showing the carriage 4 in the closed posture after insertion of the head cartridges 50, 51, FIG. 4A showing a side view and FIG. 4B showing a front view. Line segments D-D′ and B-B′ shown in FIG. 4A and line segments D-D′ and B-B′ shown in FIG. 4B indicate the same positions in the Z-direction. In the states in FIGS. 4A and 4B, the line segment B-B′ indicates the positions of the upper edges of the restriction portions 410a, 410b and is at a position higher than the positions of the upper edge portions of the fixed head cartridges and lower than the line segment D-D′ of the cover 40 which is the position of the upper edge portion of the carriage 4. In this way, the restriction portions 410a, 410b are each configured in a minimum size in the carriage 4.

In this way, in the present embodiment, the carriage 4 is provided with restriction portions (the restriction portions 410a, 410b and the restriction rib 411) that restrict movements of the head cartridge 50 in a direction (the X-direction) intersecting with the direction in which the head cartridge 50 is inserted into the housing portion 41 (the −Y-direction). Note that there may be at least one restriction portion for each cartridge, and at least one of the restriction portion 410b and the restriction rib 411 may be provided for the head cartridge 50. This can limit the trajectory of movement followed by the head cartridge at the time of insertion. This consequently helps prevent the head surface of the head cartridge from coming into contact with the carriage 4 at the time of cartridge attachment and therefore enables the cartridge to be slim.

Note that because the head cartridge 50 and the head cartridge 51 are similar to each other, the following describes the head cartridge 50 as an example.

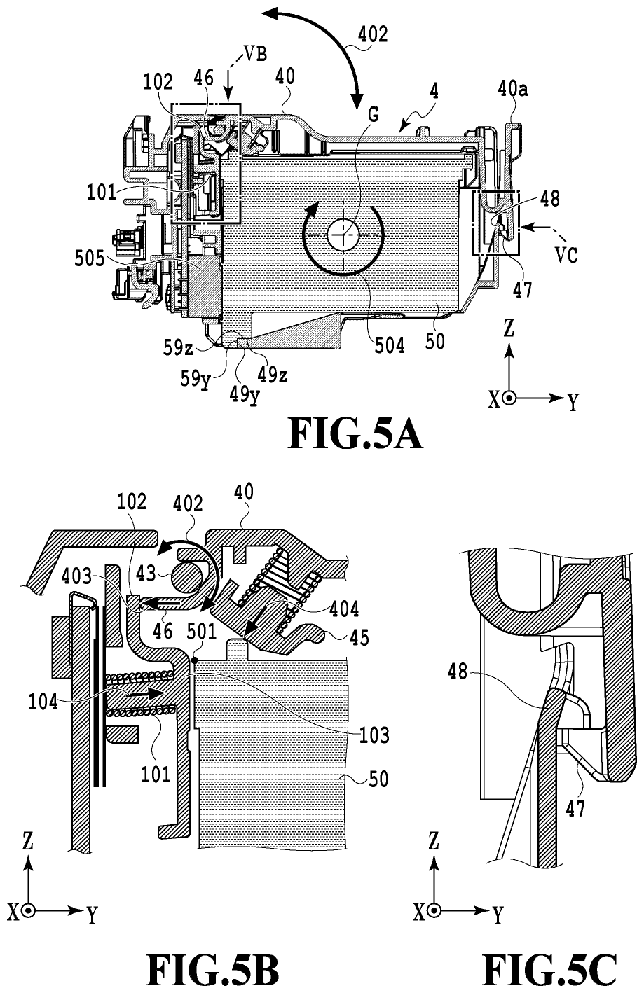

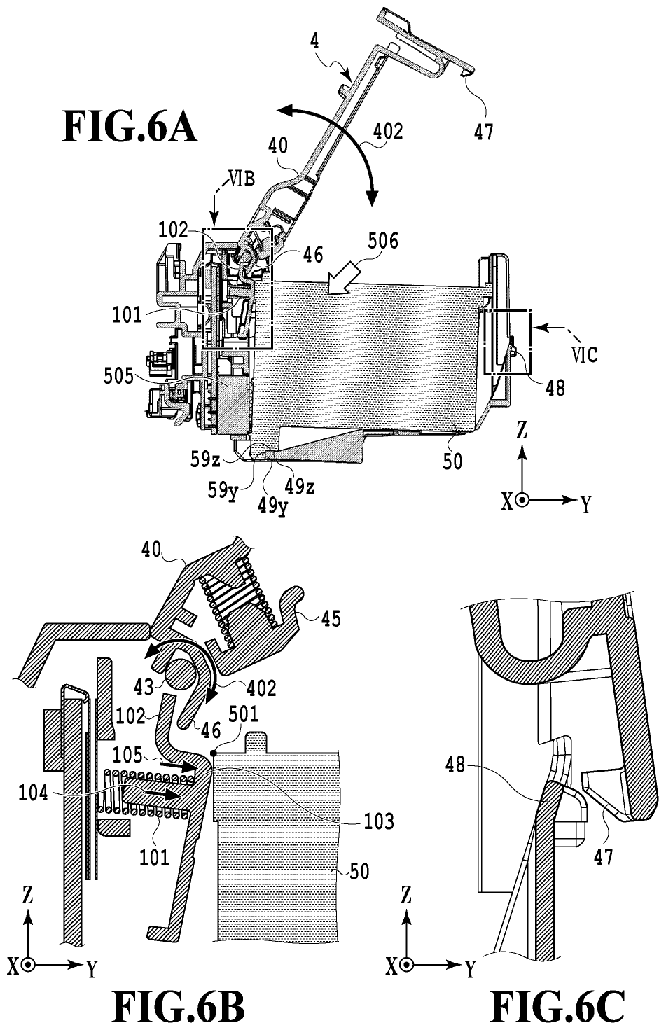

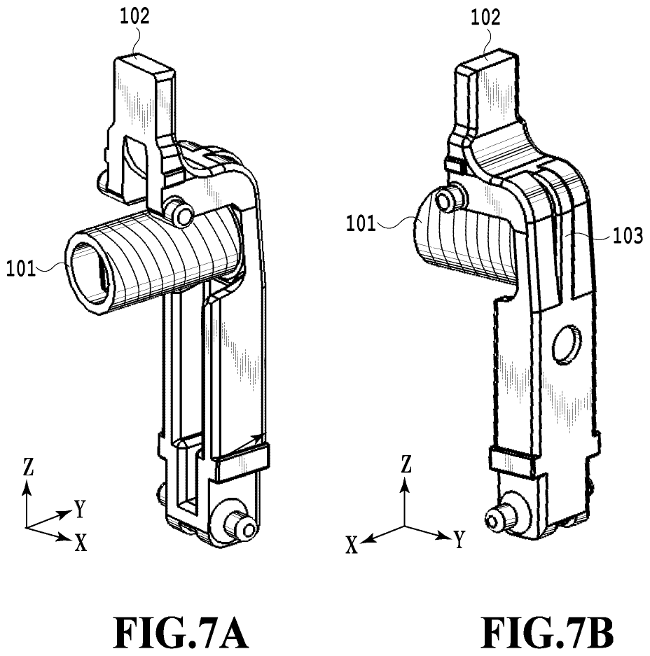

FIG. 5A is a sectional view of the carriage 4 where the cover 40 is closed and the head cartridge 50 is fixed at its attachment position, FIG. 5B is a partially enlarged view of part VB in FIG. 5A, and FIG. 5C is a partially enlarged view of part VC in FIG. 5A. FIG. 6A is a sectional view of the carriage 4 where the cover 40 is open and the head cartridge 50 is inserted, FIG. 6B is a partially enlarged view of part VIB in FIG. 6A, and FIG. 6C is a partially enlarged view of part VIC in FIG. 6A. FIGS. 7A and 7B are perspective views showing a push spring 101 and a push lever 102.

The push spring 101 is a compression spring (a coil spring) suspended between a wall surface of the carriage 4 and the push lever 102 and biases the push lever 102 in a direction of arrow 104 (see FIGS. 5B and 6B) (a direction opposite from the cartridge insertion direction). The push lever 102 biased by the push spring 101 is in abutment with a stopper (not shown) and at rest as long as the push lever 102 does not touch anything else.

Now, a description is given of an operation where a user inserts the head cartridge 50 into the carriage 4 and closes the cover 40 to bring the head cartridge 50 into abutment fixation. At the point where the user has inserted the head cartridge 50 into the carriage 4, the abutment fixation may be incomplete for such reasons as insufficient contact force on a connector 505 and interference with the push lever 102. Thus, the user turns the cover 40 clockwise in a turning direction 402 until the cover 40 is in the closed state shown in FIG. 5A.

In the process where the cover 40 turns and moves from the state in FIG. 6A to the state in FIG. 5A, first, a push-back portion 46 formed at the cover 40 comes into contact with the push lever 102 which is touching the aforementioned stopper (not shown) and at rest. Once the push-back portion 46 (part of the cover) comes into contact with the push lever 102, the push-back portion 46 pushes the push lever 102 in the direction of arrow 403 (see FIG. 5B) against the biasing force from the push spring 101. Also, once the push lever 102 is pressed, the head set cam 45 attached to the cover 40 comes into contact with the head cartridge 50 and presses the head cartridge 50 in the direction of arrow 404 (see FIG. 5B). A Y-direction abutment portion 59y provided at the head cartridge 50 which is being pressed comes into contact with a Y-direction abutment portion 49y provided at the carriage 4. Then, a Z-direction abutment portion 59y provided at the head cartridge 50 comes into contact with a Z-direction abutment portion 49z provided at the carriage 4.

In this way, the abutment portions of the head cartridge 50 come into contact with the abutment portions of the carriage 4, thereby bringing the head cartridge 50 into an abutment fixation state relative to the carriage 4. In this state, the push lever 102 is pressed by the push-back portion 46 of the cover 40 and is at a retreated position spaced apart from the head cartridge 50 fixed at the attachment position. Then, the push lever 102 stays apart so as not to affect the fixed state of the head cartridge 50. Further, once the cover 40 is operated in a closing direction, the cover 40 turns while compressing the head set cam spring (not shown) until lock portions 47, 48 disposed at a +Y-direction end portion engage with each other, and locking of the cover 40 is thus completed. FIG. 5C shows the state where locking of the cover 40 is completed.

In the event of closing the cover 40 until the lock portions 47, 48 engage, the user turns the cover 40 while applying force against the biasing force exerted by the elastic member 20 (see FIG. 2) in the direction to open the cover 40, the biasing force from the push spring 101, and the biasing force from the head set cam spring. After the lock portions 47, 48 come into engagement, the lock portions 47, 48 keep the cover 40 in the closed state. Thus, the lock portions 47, 48 and the cover 40 have such rigidity as to support forces such as the biasing force from the elastic member 20, the biasing force from the push spring 101, and the biasing force from the head set cam spring.

Note that in the state where the cover 40 is closed as shown in FIG. 5A, the user cannot apply force directly to the push lever 102 or the head cartridge 50. For this reason, the biasing force from the push spring 101 and the pressing force received from the push-back portion 46 are exerted on the push lever 102.

Except in maintenance operations such as attachment and detachment of the head cartridge 50, the cover 40 is closed as shown in FIG. 5A, and the carriage 4 either performs a printing operation or is in standby and waits for an instruction. In the state where the cover 40 is closed, the lock portion 47 provided at the cover 40 and the lock portion 48 provided at the carriage 4 are in engagement. With the cover 40 closed, the head cartridge 50 is in an abutment fixation state relative to the carriage 4, and the push lever 102 stays apart from the head cartridge 50.

With the cover 40 being closed, in order to attach or detach the head cartridge 50 at the arrival and unboxing, maintenance, or the like, the user operates an unlock portion 40a of the cover 40 to disengage the lock portions 47, 48 as shown in FIG. 6C. In order to be in the open posture shown in FIG. 6A, the cover 40 is biased by the elastic member 20 (see FIG. 2) counterclockwise as indicated by arrow 402 around the bearing portion 43 in FIG. 6B. Thus, the cover 40 is brought to the open posture by being turned until it comes into contact with an abutment member (not shown) and becomes at rest.

In the process where the cover 40 is turned and moved from the closed posture to the opened posture, first, the head cartridge 50 is released from the biasing by the head set cam 45 attached to the cover 40. However, in this state, there is friction force generated at the Z-direction and Y-direction abutment portions due to contact force exerted by the head connector 505. Thus, the posture of the head cartridge 50 does not change, and the abutment fixation is not released. Alternatively, the releasing of the biasing makes the abutment incomplete, but the posture of the head cartridge 50 is maintained due to the friction force.

Next, the push-back portion 46 formed at the cover 40 moves in a direction away from the push lever 102, which is a direction opposite from arrow 403 (see FIG. 5B). In FIG. 5B, as the push-back portion 46 is moved (in a direction opposite from the arrow 403), the push lever 102 located apart from the head cartridge 50 is released from its retreat position and is moved toward the head cartridge 50 substantially straight in the direction of arrow 104 by the biasing force from the push spring 101.

The head cartridge 50 may be present at the destination to which the push lever 102 is moved. In that case, a touch portion 103 of the push lever 102 touches the head cartridge 50 and further presses the head cartridge 50 in the direction of arrow 105 (see FIG. 6B), thereby moving and disengaging the head cartridge 50 from the abutment fixation position. After the abutment fixation to the carriage 4 is completely released, the push lever 102 touches a stopper (not shown) and stops moving.

After such a process, the cover 40 completes the turning and moving from the closed state in FIG. 5A and is now in the open state in FIG. 6A. In this state, the user removes or inserts the head cartridge 50.

In the process where the cover 40 is operated to be opened, the push spring 101 pushes the head cartridge 50 out via the push lever 102. In this event, force exerted to the push lever 102 is only the biasing force from the push spring 101 and the counterforce from the head cartridge 50 at the touch portion 103. In other words, the push lever 102 biases the cartridge 50 on the same axis as the push spring 101 in the direction in which the push spring 101 is extended or compressed.

Also, in the state where the cover 40 is open to expose the head cartridge 50 to a user as shown in FIG. 6A, the user may apply pressing force in the direction of arrow 506, pressing the head cartridge 50 into the carriage 4. In this event, the push lever 102 touching the head cartridge 50 is biased via its thickness in a direction to push back the push spring 101, which is an elastic member, i.e., in a direction opposite from arrow 105 shown in FIG. 6B. Thus, in a state where the cover 40 is open, mainly repulsive force exerted by the push spring 101 is applied to the push lever 102.

Such a configuration enables direct transmission of force from the push spring 101 to the head cartridge 50. Thus, the force of opening the cover need not be transmitted to the head cartridge via the push lever, which makes it possible to reduce the power required of the user to operate the cover. Also, there is no need to increase the spring force of an elastic member in order to reduce the force needed for the user operation, which is a concern involved in a configuration in which, e.g., an elastic member is used to pop up the cover and use this force to push out the head cartridge. Further, the cover, the lock portions, and the push lever do not need to have excessively high rigidity in order to receive the operation force and the spring force.

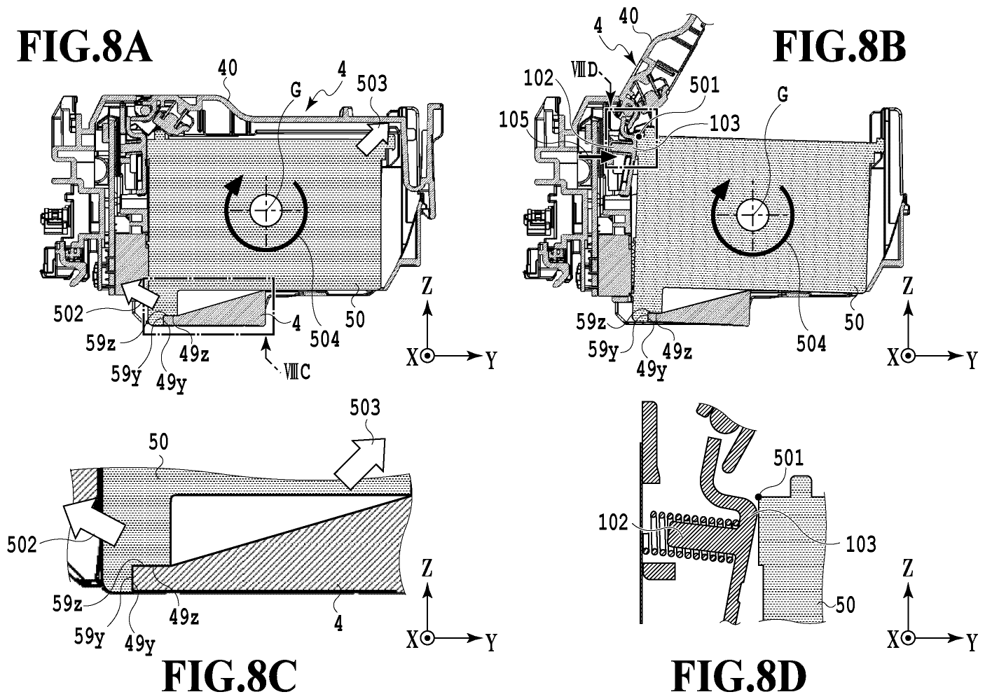

FIG. 8A is an overall view of the carriage 4 with its cover 40 closed, and FIG. 8C is an enlarged view showing part VIIID in FIG. 8A. FIG. 8B is an overall view of the carriage 4 with its cover 40 open, and FIG. 8D is an enlarged view showing part VIIID in FIG. 8B. As described earlier, in FIGS. 8A and 8C, the head cartridge 50 is such that the Y-direction abutment portion 59y and the Z-direction abutment portion 59y provided at the head cartridge 50 are in contact with the Y-direction abutment portion 49y and the Z-direction abutment portion 49z provided at the carriage 4, respectively. The head cartridge 50 is thereby in an abutment fixation state relative to the carriage 4.

To release the head cartridge 50 from the abutment fixation state, the head cartridge 50 needs to be moved in a direction away from the Y-direction abutment portion 49y and the Z-direction abutment portion 49z against which the head cartridge 50 is abutting to establish an abutment fixation state relative to the carriage 4. To promote this movement, the push lever 102 presses the head cartridge 50.

However, the direction in which the head cartridge 50 moves away in a simple straight line as indicated by arrow 502 does not coincide with a direction 503 in which the head cartridge 50 is removed. In the present embodiment, the head cartridge 50 is in abutment in the +Y-direction and in the −Z-direction. Thus, it is desirable to apply rotational force about the center of gravity as indicated by arrow 504, i.e., in a direction to release the abutment in these directions, so that the Y-direction and X-direction abutment portions may move away. Also, because the force to apply is rotational force, it goes without saying that it is desirable to give large rotational force by pressing a location far away from the center of gravity of the head cartridge 50.

Thus, as shown in FIGS. 8B and 8D, the touch portion 103 of the push lever 102 is disposed in contact with a portion of a surface to come into contact with the head cartridge 50, the portion being farthest away from the center of gravity, i.e., near an edge 501. The above configuration enables strong rotational force to be applied to the head cartridge 50 and enables the abutment fixation to be released easily with weak spring force.

In this way, the carriage 4 is provided with restriction portions (the restriction portions 410a, 410b and the restriction rib 411) that restrict movements of the head cartridge 50 in directions intersecting with the direction in which the head cartridge 50 is inserted into the housing portion 41. This can limit the trajectory of movement followed by the head cartridge at the time of insertion. This consequently helps prevent the head surface of the cartridge from coming into contact with the carriage 4 at the time of cartridge attachment. Thus, the cartridge can be made slimmer than in the prior art.

### Second Embodiment

A second embodiment of the present invention is described below with reference to the drawings. Note that because the basic configuration of the present embodiment is the same as that of the first embodiment, the following describes configurations characteristic to the present embodiment.

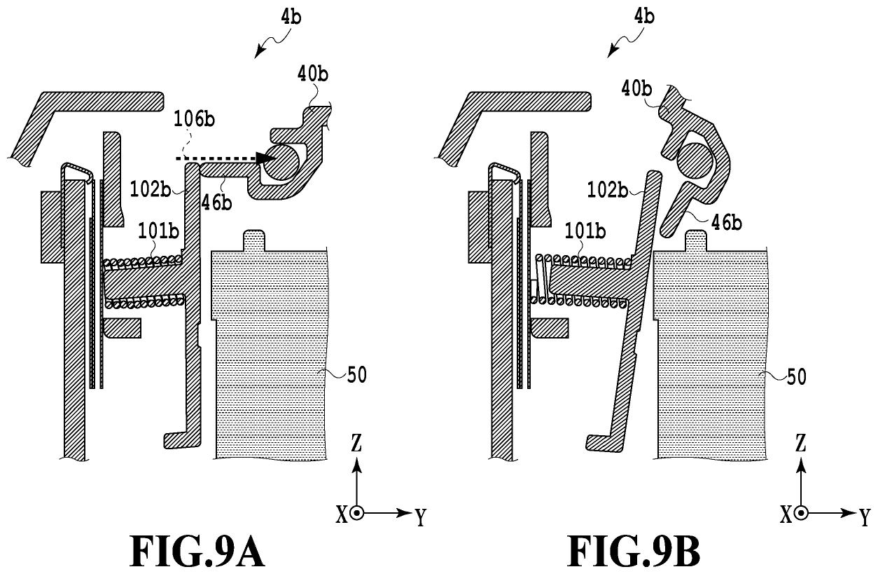

FIG. 9A is an enlarged view showing a push lever 102b in a state where a cover 40b is closed, and FIG. 9B is an enlarged view showing the push lever 102b in a state where the cover 40b is open. In the present embodiment, with the cover 40b closed, in the event where a push-back portion 46b comes into contact with the push lever 102b and pushes back the push lever 102b against the force from a push spring 101b, a line of force 106b of this repulsive force passes near the center about which the cover 40b turns. Thus, the repulsive force that the push spring 101b exerts to the cover 40b via the push lever 102b does not give rotational force to the cover 40b. Thus, even in a case where the cover 40b is pressed by the push spring 101b via the push lever 102b with the cover 40b being closed, no force is generated in a direction to open the cover 40b.

Then, the cover 40b and lock portions 47b, 48b for locking the cover 40b with the cover 40b being closed on the carriage 4 do not need to be rigid enough to receive the spring force from the push spring 101b, which makes it possible to reduce the size and weight of the apparatus. Also in such a configuration, providing the carriage 4 with restriction portions that restrict movements of the head cartridge 50 improves the precision of cartridge attachment and helps prevent the head surface from coming into contact with the carriage 4 at the time of insertion of the head cartridge.

### Third Embodiment

A third embodiment of the present invention is described below with reference to a drawing. Note that because the basic configuration of the present embodiment is the same as that of the first embodiment, the following describes configurations characteristic to the present embodiment.

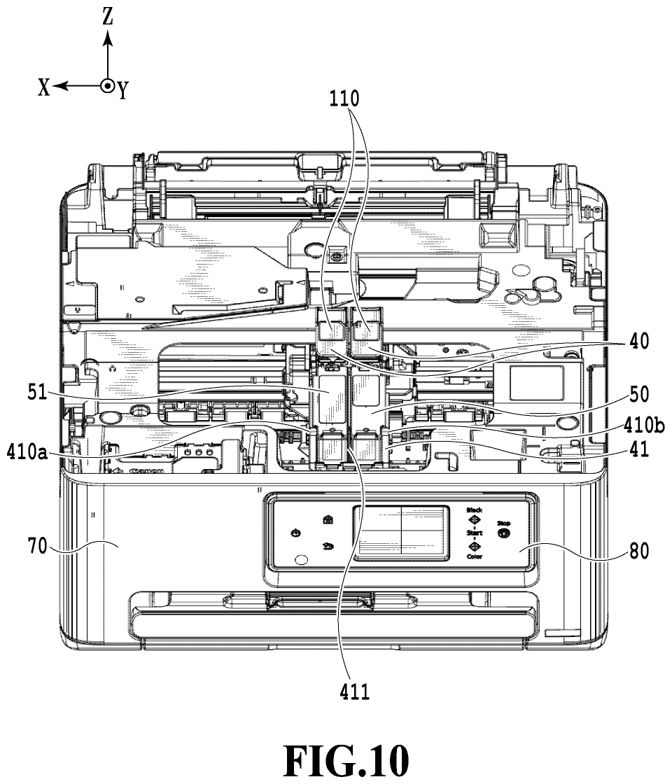

FIG. 10 is a perspective view showing, from the front, the printing apparatus M in which a front cover 70 and an operation panel 80 are attached to the front face of the printing apparatus M shown in FIG. 1. Note that the cover 40 shown in FIG. 10 is in the closed posture.

The cover 40 of the present embodiment is covers configured to turn independently for the respective head cartridges: the BK head cartridge and the CL head cartridge. Color labels 110 for the respective colors are attached to the front surfaces of the covers 40 to identify the colors of the head cartridges to be inserted therein. As shown in FIG. 10, the color labels 110 attached to the front surfaces of the covers 40 enable a configuration in which the color labels 110 are easily visible even in a case where a user opens the covers 40 to replace the head cartridge. Also in such a configuration, providing the carriage 4 with restriction portions that restrict movements of the head cartridge 50 improves the precision of cartridge attachment and helps prevent the head surface from coming into contact with the carriage 4 at the time of insertion of the head cartridge.

### Fourth Embodiment

A fourth embodiment of the present invention is described below with reference to drawings. Note that because the basic configuration of the present embodiment is the same as that of the first embodiment, the following describes configurations characteristic to the present embodiment.

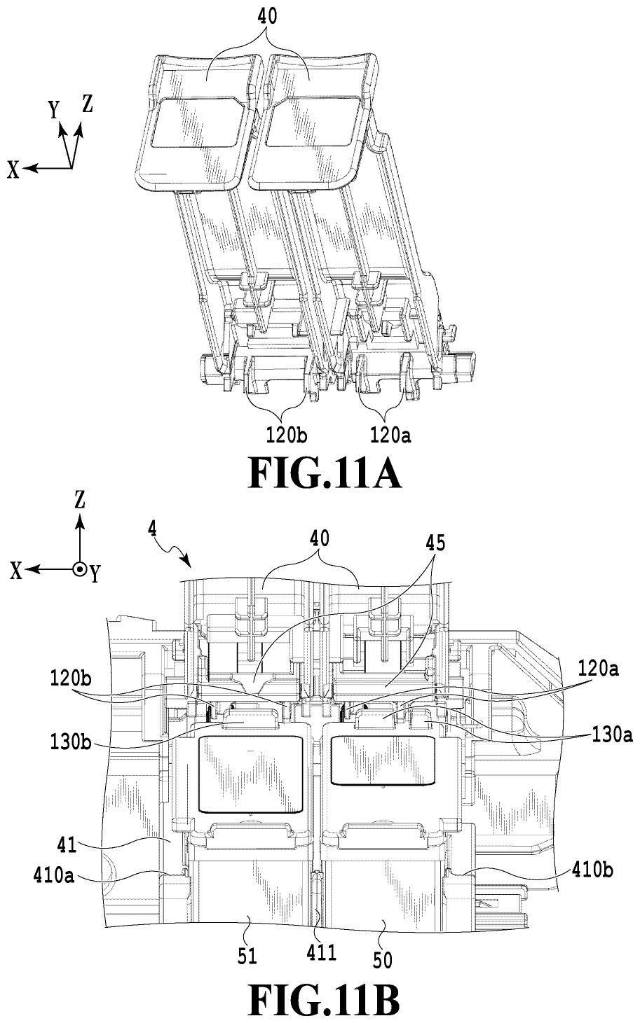

FIG. 11A is a perspective view of the covers 40 alone, seen from the lower surface side, and FIG. 11B is an enlarged front perspective view of the carriage 4, showing a state immediately before the CL head cartridge 50 and the BK head cartridge 51 are housed in the housing portions 41 with the covers 40 being open. As shown in FIG. 11A, the covers 40 of the present embodiment have, near their turning portions, protruding portions 120a, 120b for preventing the head cartridges from being erroneously attached to the housing portion 41. As shown in FIG. 11B, the protruding portions 120a, 120b of the covers 40 are provided at positions corresponding to protruding shapes 130a, 130b at the CL head cartridge 50 and the BK head cartridge 51. Specifically, the protruding portions 120a, 120b are provided at positions corresponding to the X-direction positions of the protruding shapes 130a, 130b provided at the upper surfaces of the CL head cartridge 50 and the BK head cartridge 51 as housed in the carriage 4.

Such protruding portions 120a, 120b offer an advantageous effect of reducing erroneous attachment in a case where a user tries to attach an incorrect head cartridge to the housing portion 41 because the protrusion shape on the head cartridge overlaps in the X-direction with and touch the protruding portion on the cover 40. Specifically, in a case where a user tries to attach the CL head cartridge 50 to the housing portion 41 for CL, the CL head cartridge 50 can be attached properly without the protruding shape 130a coming into contact with the protruding portion 120a. However, in a case where a user tries to attach the CL head cartridge 50 to the housing portion 41 for BK, the CL head cartridge 50 cannot be attached because the protruding shape 130a comes into contact with the protruding portion 120b. The same goes for the BK head cartridge 51. In a case where a user tries to attach the BK head cartridge 51 to the housing portion 41 for BK, the BK head cartridge 51 can be properly attached without the protruding shape 130b coming into contact with the protruding portion 120b, but in a case where a user tries to attach the BK head cartridge 51 to the housing portion 41 for CL, the BK head cartridge 51 cannot be attached because the protruding shape 130b comes into contact with the protruding portion 120a.

Also, it is conceivable to prevent erroneous attachment by providing protrusion shapes to the head set cams 45, but erroneous attachment may still occur in a case where a user tries to attach the head cartridge by applying excessive force using extension and compression of the head set cam spring that biases the head set cam 45. By contrast, providing the protruding shape to the cover 40, which is rigid and less susceptible to deformation, like in the present embodiment, can reduce erroneous attachment. Also in such a configuration, providing the carriage 4 with restriction portions that restrict movements of the head cartridge 50 improves the precision of cartridge attachment and helps prevent the head surface from coming into contact with the carriage 4 at the time of insertion of the head cartridge.

### Fifth Embodiment

A fifth embodiment of the present invention is described below with reference to drawings. Note that because the basic configuration of the present embodiment is the same as that of the first embodiment, the following describes configurations characteristic to the present embodiment.

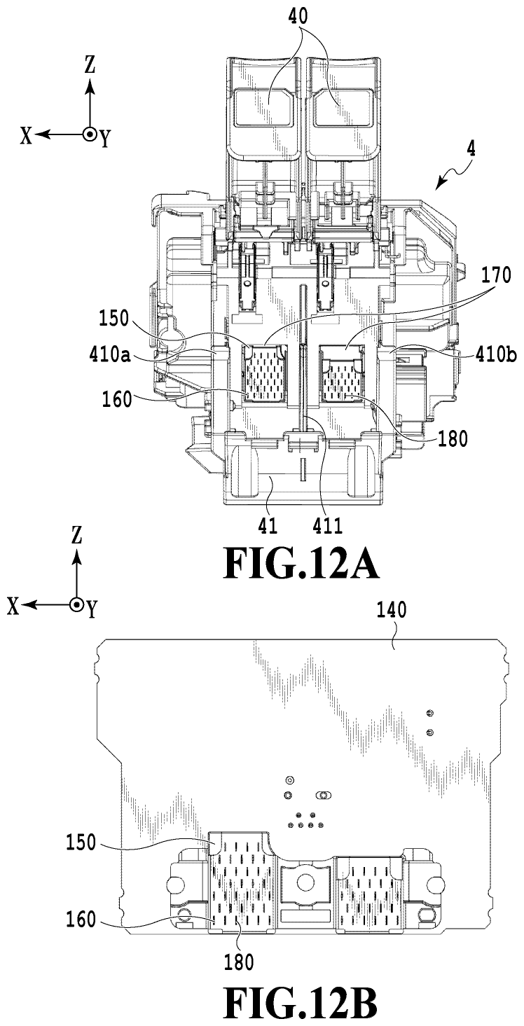

FIG. 12A is a perspective view of the carriage 4 seen from the front surface side, with the covers 40 being open and without the head cartridges being attached to the housing portions 41. As shown in FIG. 12A, in the present embodiment, openings 170 are provided at the back surfaces of the housing portions 41 housing the head cartridges: the BK head cartridge 51 and the CL head cartridge 50. Then, through the openings 170, electrical connection can be established between the head cartridges and the head connectors 150 connected to a board that the printing apparatus has.

The head connector 150 is provided with a plurality of holes 180, and a plurality of pins 160 are inserted into the holes 180. The plurality of pins 160 and the head cartridge are connected, and electrical signal exchange is performed.

FIG. 12B is a front view of the head connectors 150 and a board 140 where the head connectors 150 are placed. The head connector 150 is provided with as many holes 180 as necessary to support electric connection with head cartridges used in models different from the printing apparatus M. Providing many holes 180 in advance and adjusting the number of pins 160 inserted to the holes 180 depending on a different model enable the head connector 150 to be used across different models and enable cost reduction of the apparatus. Also in such a configuration, providing the carriage 4 with restriction portions that restrict movements of the head cartridge 50 improves the precision of cartridge attachment and helps prevent the head surface from coming into contact with the carriage 4 at the time of insertion of the head cartridge.

### OTHER EMBODIMENTS

Although the above embodiments describe a serial-scan printing apparatus M, the printing apparatus M is not limited to a serial-scan printing apparatus and may be, for example, a line-head printing apparatus, in which a head cartridge is not scanned relative to a printing medium.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-137048 filed Aug. 25, 2023, which is hereby incorporated by reference wherein in its entirety.

What is claimed is:

1. A printing apparatus comprising:
a housing portion for detachably housing a cartridge having an element substrate that ejects liquid and
a restriction portion configured to restrict movement of the cartridge in a horizontal direction intersecting with an insertion direction in which the cartridge is inserted to the housing portion, wherein
the restriction portion is provided at the housing portion at a location upstream in the insertion direction.

2. The printing apparatus according to claim 1, further comprising a cover portion configured to be movable between a first position for fixing the cartridge to the housing portion and a second position for allowing the cartridge to be attached to and detached from the housing portion.

3. The printing apparatus according to claim 2, wherein,
in a state where the cover portion is at the second position, a vertical distance from an upper edge portion of the restriction portion and a rear edge portion of the cover portion is shorter than a distance from a bottom surface to a top surface of the cartridge.

4. The printing apparatus according to claim 1, wherein
the housing portion includes a first housing portion and a second housing portion arranged in the horizontal direction, and
at least part of the restriction portion is provided between the first housing portion and the second housing portion.

5. The printing apparatus according to claim 3, wherein
in a state where the cover portion is at the first position, the upper edge portion of the restriction portion is at a higher position than the top surface of the cartridge.

6. The printing apparatus according to claim 2, wherein
the cover portion has a press portion that, at the first position, presses the cartridge inserted in the housing portion.

7. The printing apparatus according to claim 6, wherein
the press portion includes a biasing member that biases the cartridge.

8. The printing apparatus according to claim 2, wherein
the housing portion, the restriction portion, and the cover portion are mounted at a carriage configured to move in the printing apparatus.

9. The printing apparatus according to claim 8, wherein
the carriage has a push portion by which, in a state where the cover portion is at the second position, the cartridge to be housed into the housing portion is biased in a direction opposite from the insertion direction and which is, in a state where the cover portion is at the first position, located apart from the cartridge housed in the housing portion.

10. The printing apparatus according to claim 9, wherein
the push portion is biased by a push spring.

11. The printing apparatus according to claim 10, wherein
in a state where the cover portion is at the first position, part of the cover portion contacts the push portion and pushes the push portion to a position apart from the cartridge against force from the push spring.

12. The printing apparatus according to claim 10, wherein
the push spring is a coil spring, and
the push portion biases the cartridge on a same axis as the push spring in a direction in which the push spring is extended or compressed.

13. The printing apparatus according to claim 8, wherein
the carriage has a lock unit configured to lock the cover portion to the first position by bringing part of the cover portion and part of the housing portion into engagement.

14. The printing apparatus according to claim 9, wherein
in a case where the cover portion is at the first position, the push portion biases the cover portion in the direction opposite from the insertion direction using force from a push spring, and
a line of force exerted by the push portion in biasing the cover portion in the direction opposite from the insertion direction passes near a center about which the cover portion turns from the first position to the second position.

15. The printing apparatus according to claim 4, comprising a cover portion for each of the first housing portion and the second housing portion, the cover portion being movable between a first position for fixing the cartridge to the housing portion and a second position for allowing the cartridge to be attached to and detached from the housing portion.

16. The printing apparatus according to claim 2, wherein
the cover portion includes a protruding portion that contacts a protruding shape provided at a cartridge different from the corresponding cartridge to prevent attachment of the different cartridge.

17. The printing apparatus according to claim 1, wherein
the housing portion incudes an opening configured to allow electrical connection between the cartridge and a board that the printing apparatus has.
